(19) United States
(12) Patent Application Publication
(10) Pub. No.: US 2026/0362479 A1
(43) Pub. Date: Nov. 12, 2026

(54) NOTIFICATION BY AP MULTI-LINK DEVICES FOR MULTI-AP COORDINATION AND MULTI-LINK OPERATION ACROSS TWO OR MORE LINKS

(71) Applicant: Cisco Technology, Inc., San Jose, CA (US)

(72) Inventors: Brian Donald Hart, Los Altos Hills, CA (US); Binita Gupta, San Diego, CA (US); Malcolm Muir Smith, Richardson, TX (US)

(21) Appl. No.: 19/666,447

(22) Filed: May 4, 2026

Related U.S. Application Data
(60) Provisional application No. 63/800,535, filed on May 6, 2025.

(51) Int. Cl. H04W 74/04; H04W 88/08

(52) U.S. Cl. CPC H04W 74/04; H04W 88/08

(57) ABSTRACT

According to one or more embodiments of the disclosure, notification by access point (AP) multi-link devices for multi-AP coordination (MAPC) and multi-link operation (MLO) across two or more links is provided. In one embodiment, an illustrative method herein may comprise: determining, by an access point multi-link device, that a neighboring access point multi-link device is capable of multi-access-point coordination across a plurality of links; establishing, by the access point multi-link device, a coordinated operation with the neighboring access point multi-link device based on at least one shared channel condition across affiliated access points; obtaining, by the access point multi-link device, traffic information associated with one or more links of the neighboring access point multi-link device; and selecting, by the access point multi-link device, a transmission action for a transmit opportunity based on the traffic information as obtained across the plurality of links.

### RELATED APPLICATION

This application claims priority to U.S. Provisional Patent Appl Ser. No. 63/800,535, filed on May 6, 2025, entitled “NOTIFICATION BY AP MULTI-LINK DEVICES FOR MULTI-AP COORDINATION AND MULTI-LINK OPERATION ACROSS TWO OR MORE LINKS” by Brian Hart, et al., the contents of which are incorporated by reference herein.

### TECHNICAL FIELD

The present disclosure relates to wireless networking, and, more particularly, to notification by access point (AP) multi-link devices for multi-AP coordination (MAPC) and multi-link operation (MLO) across two or more links.

### BACKGROUND

Wireless access points (APs) in modern IEEE 802.11 wireless local area networks (WLANs) are increasingly configured as Multi-Link Devices (MLDs), enabling Multi-Link Operation (MLO) across multiple frequency channels. This allows traffic to be dynamically transmitted over any available link, improving throughput, latency, and reliability. In parallel, Multi-AP Coordination (MAPC) has emerged as a mechanism for coordinating transmissions among multiple APs, typically on a per-link basis, to reduce contention and improve spectral efficiency.

However, a fundamental limitation exists in conventional MAPC implementations when applied in MLO environments. Because coordination is performed independently on each link, an AP MLD operating on a given link lacks visibility into traffic transmissions that may have already occurred on other links of a neighboring AP MLD. For example, a first AP MLD operating on a first link may identify pending or overdue traffic associated with a second AP MLD, without awareness that such traffic has already been transmitted via a different link of the second AP MLD. This lack of cross-link awareness leads to redundant scheduling decisions, inefficient TXOP allocation, and suboptimal use of available airtime.

As WLAN deployments evolve toward higher determinism, ultra-high reliability, and dense multi-AP environments, these inefficiencies become more pronounced. Existing systems do not adequately account for cross-link coordination or shared scheduling intelligence across AP MLDs, resulting in fragmented coordination and reduced performance gains from MLO and MAPC when used together.

### BRIEF DESCRIPTION OF THE DRAWINGS

The detailed description is set forth below with reference to the accompanying figures. The use of the same reference numbers in different figures indicates similar or identical items. The systems depicted in the accompanying figures are not to scale and components within the figures may be depicted not to scale with each other.

FIG. 1 illustrates an example computer network.

FIG. 2 illustrates an example hardware block diagram of a device that may perform the functions of a wireless client device, access point and/or a wireless local area network controller (WLC) in connection with the techniques presented herein.

FIG. 3 illustrates an example high-level flowchart of a Multi-AP Coordination (MAPC) / Multi-Link Operation (MLO) notification mechanism according to embodiments of the present disclosure.

FIG. 4 illustrates an example block diagram of a wireless network that includes a plurality of access points (APs) that are multi-link device capable (called AP MLDs) and a plurality of stations that are also multi-link device capable (called non-AP MLDs), where the AP MLDs are configured to perform MAPC exchanges to coordinate MLO across links, according to an example embodiment.

FIG. 5 illustrates an example simplified procedure for notification by AP multi-link devices for MAPC and MLO across two or more links in accordance with one or more embodiments described herein.

### DESCRIPTION OF EXAMPLE EMBODIMENTS

### Overview

According to one or more embodiments of the disclosure, notification by access point (AP) multi-link devices for multi-AP coordination (MAPC) and multi-link operation (MLO) across two or more links is provided. In one embodiment, an illustrative method herein may comprise: determining, by an access point multi-link device, that a neighboring access point multi-link device is capable of multi-access-point coordination across a plurality of links; establishing, by the access point multi-link device, a coordinated operation with the neighboring access point multi-link device based on at least one shared channel condition across affiliated access points; obtaining, by the access point multi-link device, traffic information associated with one or more links of the neighboring access point multi-link device; and selecting, by the access point multi-link device, a transmission action for a transmit opportunity based on the traffic information as obtained across the plurality of links.

Other implementations are described below, and this overview is not meant to limit the scope of the present disclosure.

### Example Embodiments

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

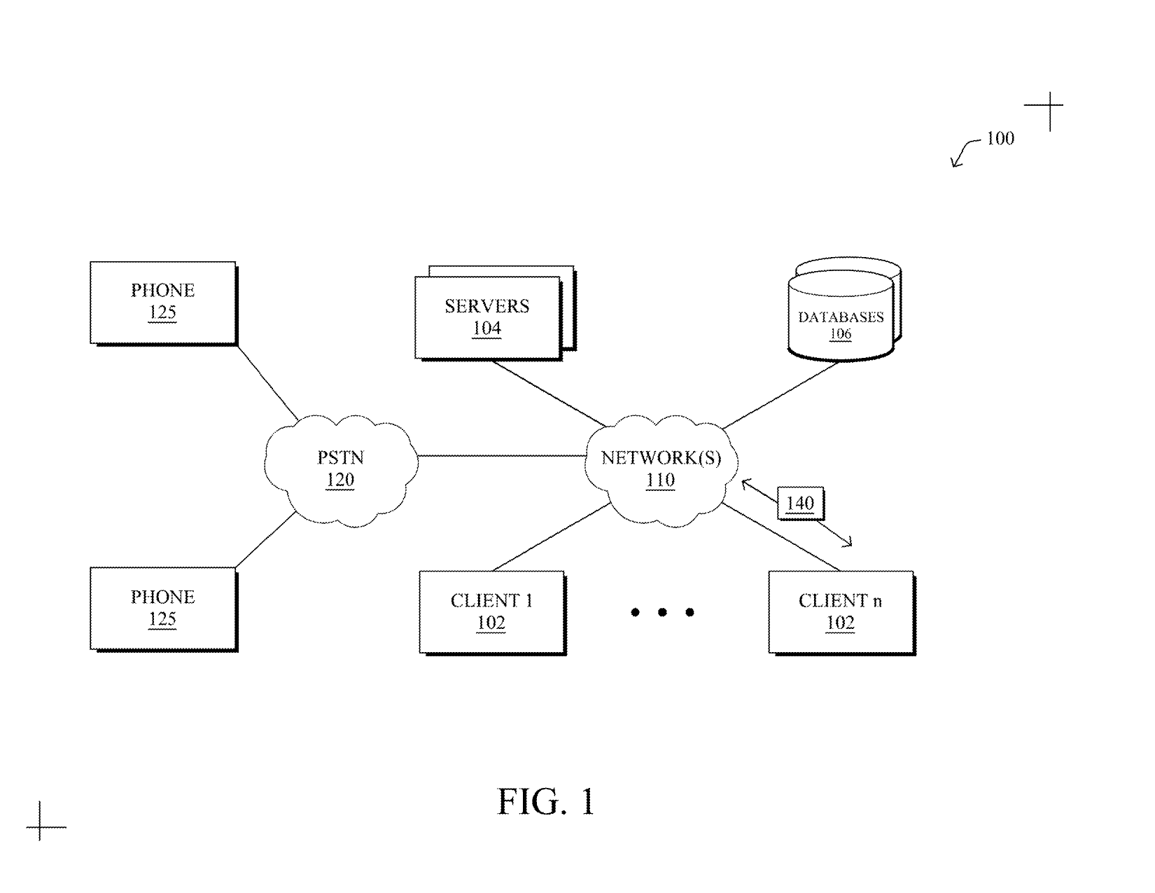

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on Wi-Fi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, a web server, etc.

In addition, a separate public switched telephone network (PSTN 120) may also be considered to be a part of computing system 100, namely where phones 125 connect to the PSTN 120 in a standard manner (e.g., landlines, cellphones, and so on). The PSTN may be based on any number of carrier telephone networks which provide a connection to network(s) 110 for things such as conference calls, video calls, calls to voice over IP (VoIP) end points, and so on, as will be readily understood by those skilled in the art.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user’s data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to route a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, thereby forming a virtual connection between local networks and data center/cloud environments on top of the various underlying connections. Another feature of SD-WAN is centralized management by a supervisory service that can monitor and adjust the various connections, as needed.

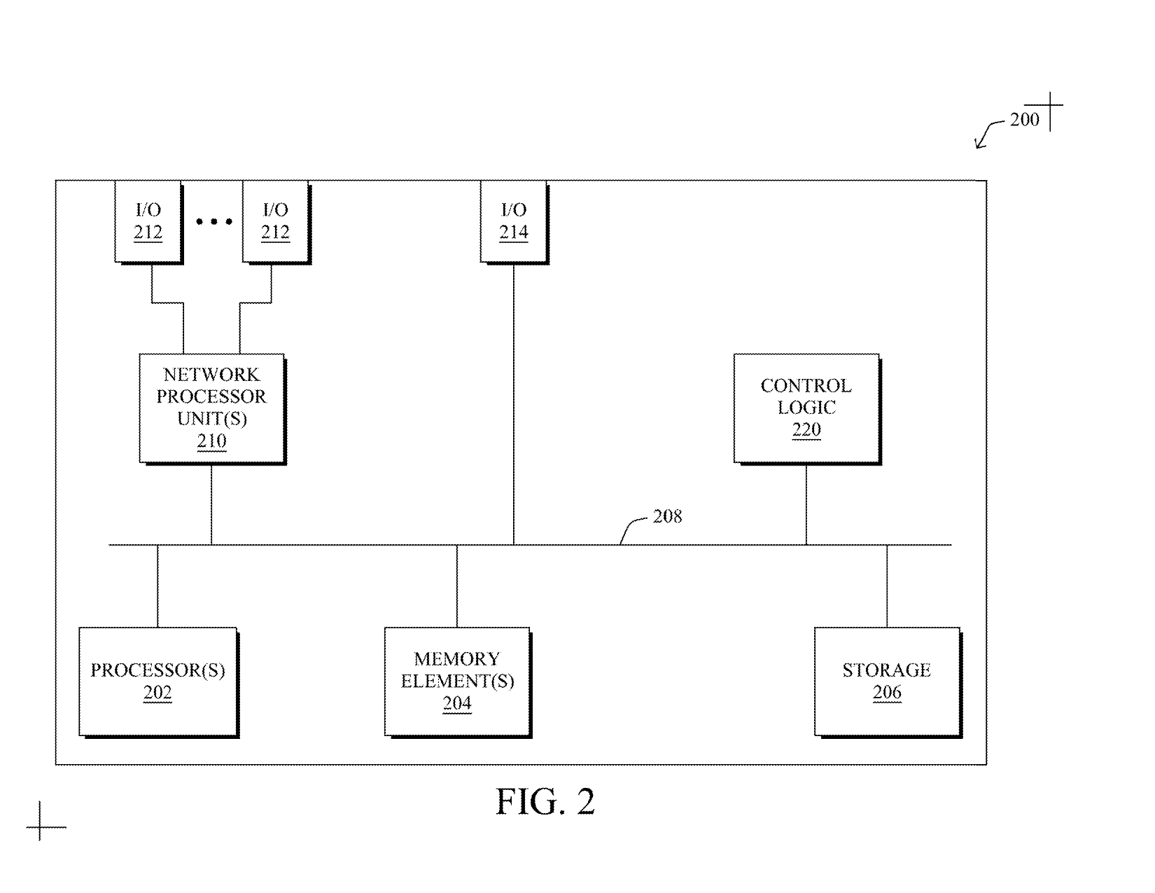

FIG. 2 illustrates a hardware block diagram of a device 200 that may perform functions associated with operations discussed herein in connection with the techniques presented herein. In various embodiments, a computing device or apparatus, such as device 200 or any combination of devices like device 200, may be configured as any entity/entities as discussed for the techniques presented herein in order to perform operations of the various techniques discussed herein. The device 200 may represent a wireless client device, an AP or a wireless network controller.

In at least one embodiment, the device 200 may be any apparatus that may include one or more processor(s) 202, one or more of memory element(s) 204, storage 206, a bus 208, one or more network processor unit(s) 210 interconnected with one or more network input/output (I/O) interface(s) (network I/O interface(s) 212), one or more I/O interface(s) 214, and control logic 220. In various embodiments, instructions associated with logic for device 200 can overlap in any manner and are not limited to the specific allocation of instructions and/or operations described herein.

In at least one embodiment, processor(s) 202 is/are at least one hardware processor configured to execute various tasks, operations and/or functions for device 200 as described herein according to software and/or instructions configured for device 200. Processor(s) 202 (e.g., a hardware processor) can execute any type of instructions associated with data to achieve the operations detailed herein. In one example, processor(s) 202 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term 'processor'.

In at least one embodiment, memory element(s) 204 and/or storage 206 is/are configured to store data, information, software, and/or instructions associated with device 200, and/or logic configured for memory element(s) 204 and/or storage 206. For example, any logic described herein (e.g., control logic 220) can, in various embodiments, be stored for device 200 using any combination of memory element(s) 204 and/or storage 206. Note that in some embodiments, storage 206 can be consolidated with memory element(s) 204 (or vice versa), or can overlap/exist in any other suitable manner.

In at least one embodiment, bus 208 can be configured as an interface that enables one or more elements of device 200 to communicate in order to exchange information and/or data. Bus 208 can be implemented with any architecture designed for passing control, data and/or information between processors, memory elements/storage, peripheral devices, and/or any other hardware and/or software components that may be configured for device 200. In at least one embodiment, bus 208 may be implemented as a fast kernel-hosted interconnect, potentially using shared memory between processes (e.g., logic), which can enable efficient communication paths between the processes.

In various embodiments, network processor unit(s) 210 may enable communication between device 200 and other systems, entities, etc., via network I/O interface(s) 212 (wired and/or wireless) to facilitate operations discussed for various embodiments described herein. In various embodiments, network processor unit(s) 210 can be configured as a combination of hardware and/or software, such as one or more Ethernet driver(s) and/or controller(s) or interface cards, Fibre Channel (e.g., optical) driver(s) and/or controller(s), wireless receivers/ transmitters/transceivers, baseband processor(s)/modem(s), and/or other similar network interface driver(s) and/or controller(s) now known or hereafter developed to enable communications between device 200 and other systems, entities, etc. to facilitate operations for various embodiments described herein. In various embodiments, network I/O interface(s) 212 can be configured as one or more Ethernet port(s), WLAN interfaces, Fibre Channel ports, any other I/O port(s), and/or antenna(s)/antenna array(s) now known or hereafter developed. Thus, the network processor unit(s) 210 and/or network I/O interface(s) 212 may include suitable interfaces for receiving, transmitting, and/or otherwise communicating data and/or information in a network environment.

I/O interface(s) 214 allow for input and output of data and/or information with other entities that may be connected to device 200. For example, I/O interface(s) 214 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 220 can include instructions that, when executed, cause processor(s) 202 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 220) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term 'memory element'. Data/information being tracked and/or sent to one or more entities as discussed herein could be provided in any database, table, register, list, cache, storage, and/or storage structure: all of which can be referenced at any suitable timeframe. Any such storage options may also be included within the broad term 'memory element' as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 204 and/or storage 206 can store data, software, code, instructions (e.g., processor instructions), logic, parameters, combinations thereof, and/or the like used for operations described herein. This includes memory element(s) 204 and/or storage 206 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Notification by AP Multi-Link Devices for MAPC and MLO

As noted above, existing WLAN systems that implement Multi-Link Operation (MLO) and Multi-AP Coordination (MAPC) operate coordination on a per-link basis, which prevents access points from having visibility into traffic activity occurring on other links of neighboring multi-link devices. This lack of cross-link awareness leads to redundant scheduling decisions, inefficient transmit opportunity allocation, and underutilization of network resources, particularly in dense or high-reliability wireless environments.

The techniques herein, therefore, provide for notification by access point (AP) multi-link devices for multi-AP coordination (MAPC) and multi-link operation (MLO) across two or more links. In particular, as described in greater detail below, the techniques herein enable synergistic operation of MAPC and MLO by introducing cross-link coordination mechanisms among AP Multi-Link Devices (AP MLDs). These techniques include aligning operating channels among AP MLDs, sharing traffic scheduling information across links, and using aggregated cross-link intelligence to make improved transmit opportunity (TXOP) allocation decisions.

Said differently, the disclosed system allows AP MLDs to move beyond isolated per-link coordination and instead operate with a shared awareness of traffic conditions across multiple links. By pooling scheduling inputs, buffering information, and service period status across links, AP MLDs can avoid redundant transmissions, prioritize higher-value traffic flows, and dynamically select which AP should be granted airtime.

More specifically, AP MLDs may signal their capability to perform cross-link MAPC coordination, align their affiliated AP channel configurations, negotiate coordinated operation, and exchange multi-link traffic state information. When a transmit opportunity is obtained, an AP may query neighboring APs for buffered traffic across links and use this information to determine how to utilize or delegate the TXOP. This results in more efficient spectrum usage, reduced latency, and improved determinism in multi-AP wireless networks.

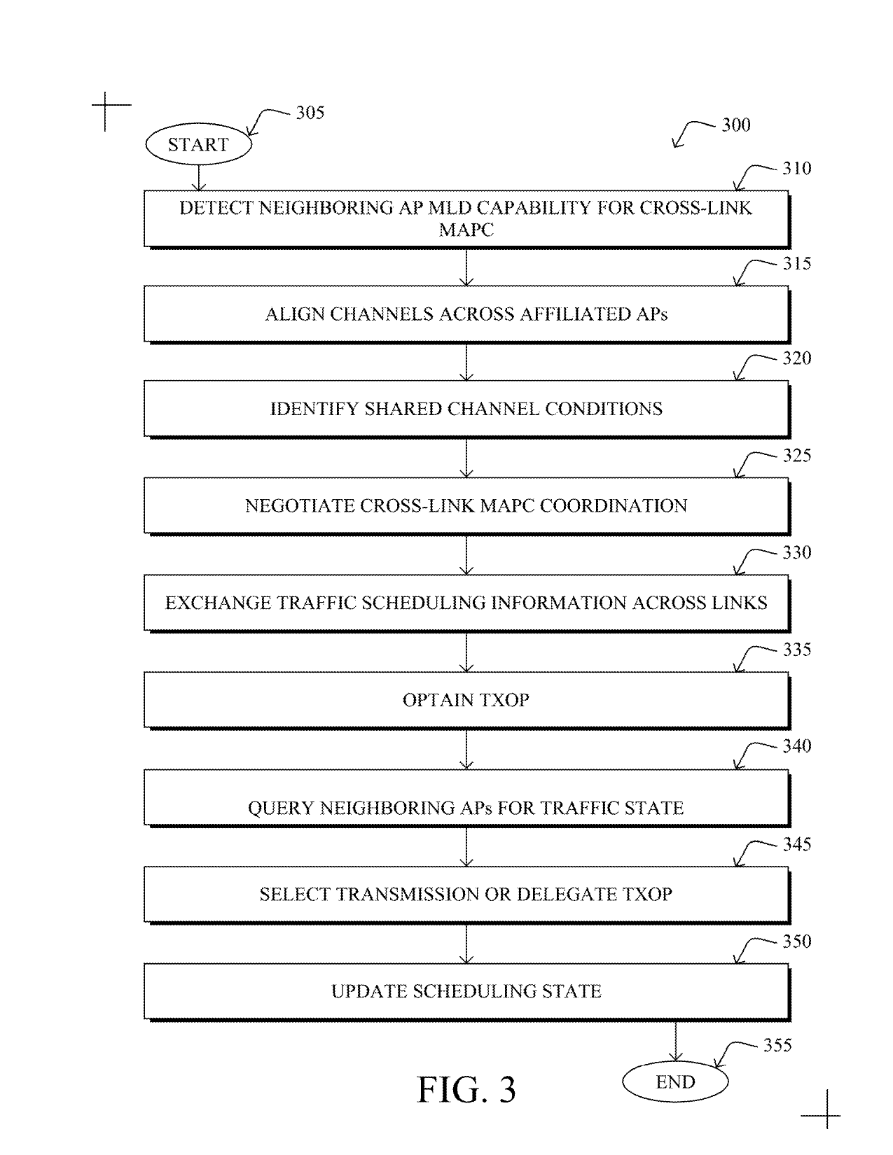

FIG. 3 illustrates an example high-level flowchart 300 of an illustrative “MAPC/MLO Notification” mechanism herein, particularly for coordinating multi-link operation across multiple AP MLDs. The process begins at step 305, and continues to step 310 where an AP MLD determines whether neighboring AP MLDs support coordination across links (“Detect neighboring AP MLD capability for cross-link MAPC”). At step 315, the AP MLD may bias its channel selection to align with those neighboring AP MLDs. At step 320, shared channel conditions are identified, such as a common primary channel.

At step 325, the AP MLD negotiates coordinated MAPC operation across links. At step 330, traffic scheduling information is exchanged, including buffered traffic and link eligibility. Upon obtaining a transmit opportunity in step 335, the AP MLD queries neighboring APs for updated traffic information in step 340.

At step 345, the AP MLD selects a transmission action, such as transmitting its own traffic or delegating the TXOP to another AP. Finally, at step 350, the AP MLD updates its scheduling state and cached information for future coordination, and the flowchart ends in step 355.

Operationally, and now in greater detail, the techniques herein illustratively operate within a wireless local area network (WLAN) that includes multiple AP Multi-Link Devices (AP MLDs), each comprising a plurality of affiliated access points capable of operating on different links. These AP MLDs interact with non-AP MLD stations (STAs) that also support multi-link operation.

A key aspect of the techniques herein is the introduction of cross-link coordination awareness. Each AP MLD may first signal its capability to perform MAPC coordination across links. This signaling may be included in an Ultra High Reliability (UHR) capability/operation element or a dedicated element (e.g., MAPC element), enabling neighboring AP MLDs to identify compatible devices.

Once capability is established, an AP MLD may bias its channel selection strategy. Rather than independently selecting channels, the AP MLD aligns the operating channels of its affiliated APs with those of neighboring AP MLDs. This alignment increases the likelihood that at least two affiliated APs from different AP MLDs share a common primary channel, thereby enabling coordinated operation. In particular, if a first AP MLD (e.g., “AP MLD 1”) is aware of a second AP MLD (e.g., “AP MLD 2”) that can perform MAPC with coordination across links, and the first AP MLD 1 is capable of MAPC with coordination across links, then the first AP MLD 1 can bias its channel selection so that the set of channels of its affiliated APs align with the set of channels of the second AP MLD 2’s affiliated APs, accordingly.

Coordination is further enabled through identification of shared channel conditions (e.g., a common 20MHz primary channel even if the operating channels are not identical). This may be accomplished through beacon scanning, AP-to-AP (AP2AP) communication protocols, or centralized coordination via a WLAN controller (WLC) or cloud-based management platform. Once shared channels are identified, AP MLDs may negotiate to enable MAPC with cross-link coordination.

Following negotiation, AP MLDs exchange traffic scheduler inputs of their clients (non-AP MLDs). These inputs include buffered traffic information associated with their respective STAs, as well as indications of which links are capable of carrying that traffic, which might include links outside the negotiated MLO MAPC links / all of the negotiated MLO MAPC links or a subset thereof (including just a single link). This may be represented using bitmaps or similar structures that define link eligibility for transmission.

When an affiliated AP obtains a transmit opportunity (TXOP), it does not act in isolation. Instead, it queries neighboring AP MLDs for their buffered traffic states, including both uplink (UL) and downlink (DL) traffic across multiple links that is understood to be buffered at the MLDs of their Basic Service Sets (BSSs). The solicited responses may include traffic specific to the current link (e.g., for any client that could use on this link) as well as traffic eligible for other links, along with differential (delta) information.

This information may be cached by recipient AP MLDs and used as a reasonable default for other links, especially for traffic that can only be sent on that other link (e.g., as a predictive scheduling input). For example, if a neighboring AP has already transmitted certain traffic on another link, this information prevents redundant scheduling. Conversely, if high-priority traffic remains buffered on another AP, the TXOP may be delegated using mechanisms such as Coordination Time Division Multiple Access (C-TDMA).

Further, where service period block acknowledgments (SP BAs) are transmitted, they may include aggregated information across all coordinated links, enabling AP MLDs to track completed and outstanding service periods holistically (e.g., SP BA information about SPs completed and/or outstanding may include information from all the negotiated links).

As noted, where C-TDMA is used to hand over a portion or the remainder of a TXOP to another AP, the granting AP may cross-off traffic (for all the granting AP’s links) reported by that AP that could be sent on this link, especially if it is higher priority traffic than other flows that might need to be serviced shortly.

The selection of which AP is granted transmission time according to one or more embodiments herein is therefore based on a multi-dimensional view of traffic across links, rather than a single-link perspective. For example, the selection of the next AP(s) to grant time to (e.g., via C-TDMA) is responsive to the MLO MAPC information received from those APs, their AP MLDs, and affiliated APs of those AP MLDs. This enables improved prioritization, reduced latency, and more efficient spectrum utilization.

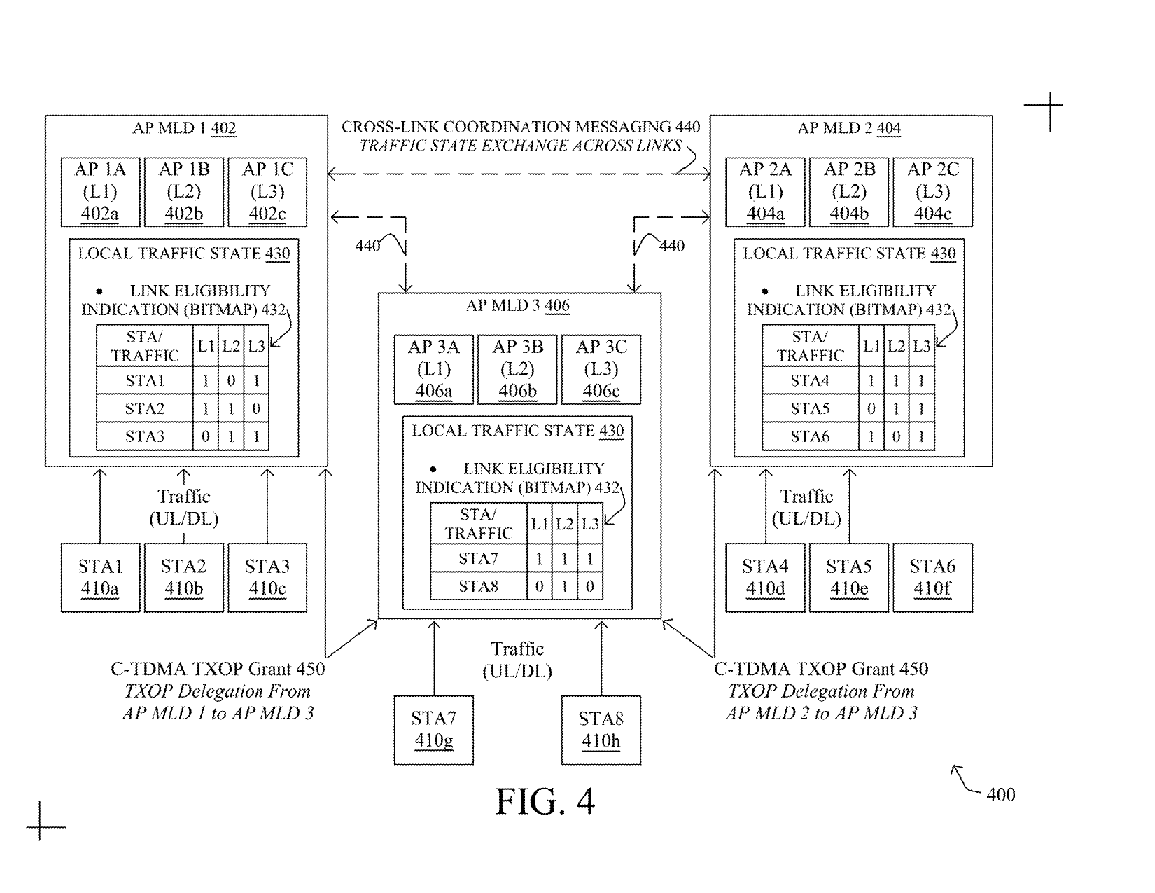

Referring now to FIG. 4, a wireless communication system (system 400) is illustrated in which a plurality of access point multi-link devices (AP MLDs) are configured to perform coordinated multi-link operation across two or more links using multi-AP coordination (MAPC) techniques.

In the illustrated embodiment, the system 400 includes a first AP MLD 402 (“AP MLD 1”), a second AP MLD 404 (“AP MLD 2”), and a third AP MLD 406 (“AP MLD 3”). Each AP MLD comprises a plurality of affiliated access points (APs), which collectively operate as a single multi-link device capable of multi-link operation (MLO). For example, AP MLD 1 includes affiliated APs 402a, 402b, and 402c operating on Link 1 (L1), Link 2 (L2), and Link 3 (L3), respectively. Similarly, AP MLD 2 includes affiliated APs 404a, 404b, and 404c, while AP MLD 3 includes affiliated APs 406a, 406b, and 406c, each operating on corresponding links.

A plurality of stations (“STAs 410” generally) are associated with the AP MLDs. The STAs are capable of generating uplink (UL) and downlink (DL) traffic that may be transmitted over one or more links of the associated AP MLD. Traffic associated with the STAs is buffered at the AP MLDs and may be eligible for transmission on multiple links depending on channel conditions, link availability, or other transmission constraints. As shown, STA1 410a, STA2 410b, and STA3 410c communicate with AP MLD 1, STA4 410d, STA5 410e, and STA6 410f communicate with AP MLD 2, and STA7 410g and STA8 410h communicate with AP MLD 3.

Each AP MLD maintains a local traffic state 430 that includes buffered traffic (UL/DL traffic) associated with one or more STAs. The local traffic state further includes a link eligibility indication 432, which specifies, for each traffic flow or STA, the set of links on which the traffic may be transmitted. In some embodiments, the link eligibility indication is represented as a bitmap in which each bit corresponds to a respective link (e.g., L1, L2, L3), and the value of each bit indicates whether the traffic is eligible for transmission on that link. Notably, the format of the link eligibility indication 432 is merely an example, and not meant to limit the scope of the embodiments herein.

In accordance with the techniques described herein, AP MLDs exchange cross-link coordination information via cross-link coordination messaging 440. The cross-link coordination messaging 440 is illustrated using dashed communication paths between AP MLDs and represents the exchange of traffic state information, including buffered traffic, link eligibility indications, and scheduling-related information. The exchanged information may include traffic associated with the current link as well as traffic eligible for transmission on other links, and may further include differential updates relative to previously exchanged information.

Through the exchange of cross-link coordination messaging 440, each AP MLD is able to construct and maintain an extended cross-link traffic view that includes both locally buffered traffic and traffic information associated with neighboring AP MLDs. In some embodiments, this information may be cached and used as a predictive or default representation of traffic conditions on links that are not directly observable by a given AP MLD.

In operation, when an affiliated AP of an AP MLD obtains a transmit opportunity (TXOP) on a given link, such as Link 1, the AP MLD may utilize both local traffic state and cross-link coordination information to determine how to utilize the TXOP. For example, the AP MLD may evaluate locally buffered traffic that is eligible for transmission on the current link, as well as traffic reported by neighboring AP MLDs that may also be transmitted on the current link or on other links.

Based on this aggregated cross-link information, the AP MLD may select a transmission action. In some cases, the AP MLD transmits its own buffered traffic. In other cases, the AP MLD may allocate or delegate at least a portion of the TXOP to another AP MLD using a coordination mechanism, such as coordinated time division multiple access (C-TDMA). Such TXOP delegation is illustrated by grants 450 between AP MLDs.

In some embodiments, when an AP MLD delegates a TXOP to another AP MLD, the granting AP MLD updates its traffic state to reflect that certain traffic has been serviced or is expected to be serviced by the receiving AP MLD. This update may be applied across multiple links associated with the AP MLD, thereby preventing redundant scheduling of the same traffic on different links.

Additionally, cross-link coordination messaging 440 may include information related to service periods, including indications of completed service periods and outstanding service periods across links. This allows AP MLDs to maintain a consistent view of scheduling progress across multiple links and across multiple AP MLDs.

Accordingly, FIG. 4 illustrates a system-level architecture in which multi-link operation and multi-AP coordination are integrated through cross-link coordination messaging, link eligibility representations, and TXOP delegation mechanisms, enabling coordinated scheduling decisions across multiple links and multiple AP MLDs.

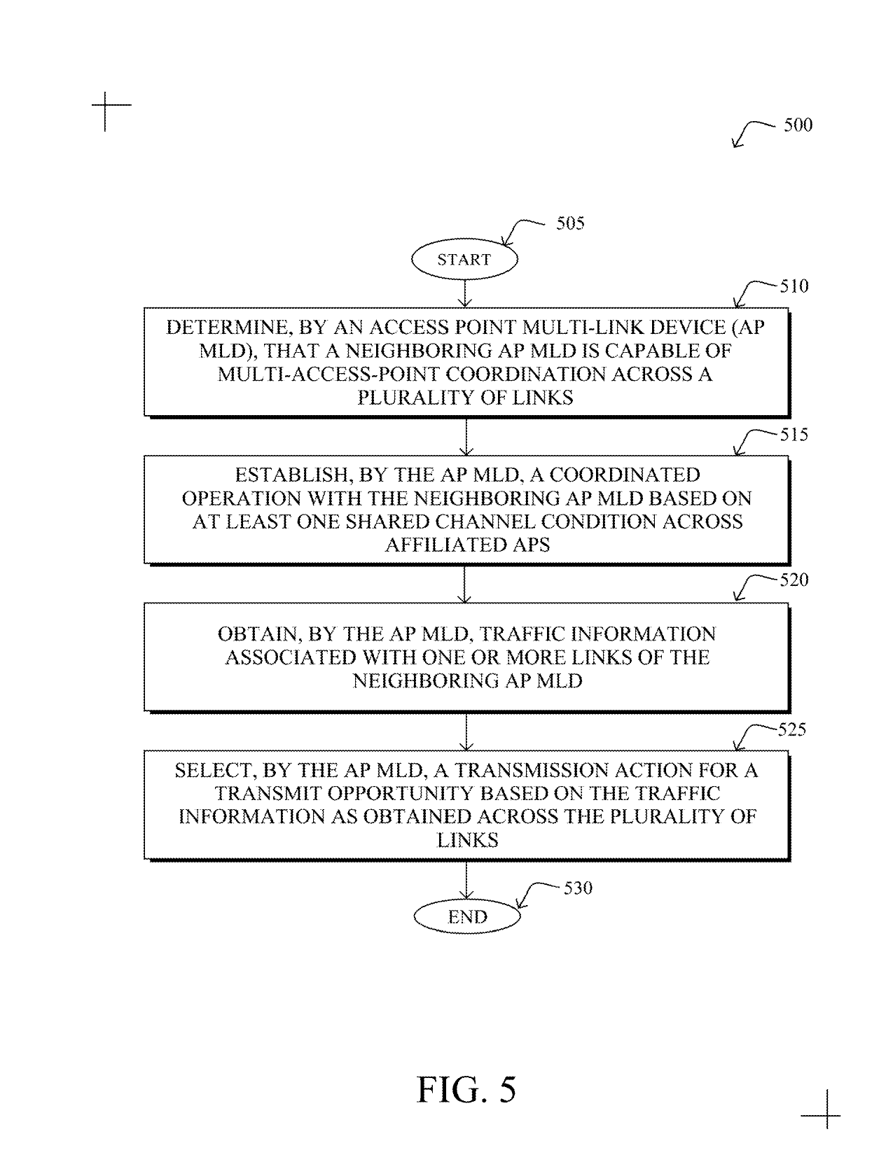

In closing, FIG. 5 illustrates an example simplified procedure for notification by access point (AP) multi-link devices for multi-AP coordination (MAPC) and multi-link operation (MLO) across two or more links in accordance with one or more embodiments described herein. For example, a non-generic, specifically configured device (e.g., an apparatus) may perform procedure 500 (e.g., a method) by executing stored instructions (e.g., a process). Procedure 500 may start at step 505 and continues to step 510, where, as described in greater detail above, an access point multi-link device (AP MLD) determines that a neighboring AP MLD is capable of multi-access-point coordination across a plurality of links (e.g., by receiving capability signaling in a multi-link operation (MLO) element).

In step 515, the AP MLD may then establish a coordinated operation with the neighboring AP MLD based on at least one shared channel condition across affiliated access points (e.g., identifying a shared primary channel between affiliated access points). Accordingly, in step 520, the AP MLD may then obtain traffic information associated with one or more links of the neighboring AP MLD (e.g., an indication of links on which traffic is eligible to be transmitted). In one embodiment, this may specifically involve receiving buffered traffic information for uplink and downlink traffic, as noted above.

According to the techniques herein, in step 525, the AP MLD may then select a transmission action for a transmit opportunity based on the traffic information as obtained across the plurality of links, such as, for example, granting at least a portion of the transmit opportunity to another access point, prioritizing traffic based on information aggregated across multiple links, and so on. Also, in certain embodiments, the transmission action may be based further on service period block acknowledgment (SP BA) information aggregated across multiple links, as discussed above.

The procedure 500 may then end in step 530, notably with the ability to continue coordination for further transmissions (e.g., and optionally caching the traffic information as obtained for use in subsequent transmit opportunities). Note, too, that the procedure 500 may include other steps not specifically shown, such as biasing channel selection of affiliated access points to align with channels of the neighboring AP MLD, and so forth, as described in greater detail above.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

The techniques described herein, therefore, provide for notification by access point (AP) multi-link devices for multi-AP coordination (MAPC) and multi-link operation (MLO) across two or more links. In particular, the techniques herein improve wireless network efficiency by enabling AP MLDs to coordinate scheduling decisions across multiple links rather than independently per link. This reduces redundant transmissions, improves utilization of available spectrum, and enables more intelligent TXOP allocation. The system enhances latency, throughput, and determinism, particularly in dense deployments and high-reliability environments.

Compared to existing approaches, which treat each link independently, the present disclosure introduces a shared cross-link awareness that fundamentally improves coordination. Unlike prior systems that lack visibility across links, the disclosed techniques allow APs to make informed decisions based on aggregated traffic conditions, resulting in superior performance and scalability.

In alternative embodiments, coordination may be performed via centralized controllers, distributed AP-to-AP protocols, or hybrid approaches. The techniques may be applied across different frequency bands, including 2.4 GHz, 5 GHz, and 6 GHz, and may extend to future wireless standards beyond IEEE 802.11bn. Moreover, traffic information exchange may use compressed representations, probabilistic models, or machine learning-based predictions. Coordination mechanisms may also be integrated with quality-of-service enforcement, network slicing, or deterministic networking protocols.

In some implementations, an illustrative method herein may comprise: determining, by an access point multi-link device, that a neighboring access point multi-link device is capable of multi-access-point coordination across a plurality of links; establishing, by the access point multi-link device, a coordinated operation with the neighboring access point multi-link device based on at least one shared channel condition across affiliated access points; obtaining, by the access point multi-link device, traffic information associated with one or more links of the neighboring access point multi-link device; and selecting, by the access point multi-link device, a transmission action for a transmit opportunity based on the traffic information as obtained across the plurality of links.

In one embodiment, determining capability comprises: receiving capability signaling in a multi-link operation element.

In one embodiment, the method further comprises: biasing channel selection of affiliated access points to align with channels of the neighboring access point multi-link device.

In one embodiment, establishing coordinated operation comprises: identifying a shared primary channel between affiliated access points.

In one embodiment, obtaining traffic information comprises: receiving buffered traffic information for uplink and downlink traffic.

In one embodiment, the traffic information includes an indication of links on which traffic is eligible to be transmitted.

In one embodiment, selecting the transmission action comprises: granting at least a portion of the transmit opportunity to another access point.

In one embodiment, selecting the transmission action comprises: prioritizing traffic based on information aggregated across multiple links.

In one embodiment, the method further comprises: caching the traffic information as obtained for use in subsequent transmit opportunities.

In one embodiment, the transmission action is based further on service period block acknowledgment information aggregated across multiple links.

In still other implementations, an illustrative apparatus herein may comprise: one or more network interfaces to communicate with a wireless network; a processor coupled to the one or more network interfaces and configured to execute one or more processes; and a memory configured to store a process that is executable by the processor for operating as an access point multi-link device, the process comprising: determining that a neighboring access point multi-link device is capable of multi-access-point coordination across a plurality of links; establishing a coordinated operation with the neighboring access point multi-link device based on at least one shared channel condition across affiliated access points; obtaining traffic information associated with one or more links of the neighboring access point multi-link device; and selecting a transmission action for a transmit opportunity based on the traffic information as obtained across the plurality of links.

In still other implementations, a tangible, non-transitory computer-readable medium may store computer-executable instructions that, when executed by one or more processors, cause a device to perform operations comprising: determining, as an access point multi-link device, that a neighboring access point multi-link device is capable of multi-access-point coordination across a plurality of links; establishing a coordinated operation with the neighboring access point multi-link device based on at least one shared channel condition across affiliated access points; obtaining traffic information associated with one or more links of the neighboring access point multi-link device; and selecting a transmission action for a transmit opportunity based on the traffic information as obtained across the plurality of links.

Illustratively, the techniques described herein may be performed by hardware, software, and/or firmware, (e.g., an “apparatus”) such as in accordance with an MAPC/MLO Notification process (e.g., a “method”), which may include computer-executable instructions executed by processor(s) to perform functions relating to the techniques described herein, e.g., in conjunction with corresponding processes of other devices in the computer network as described herein (e.g., on computing devices, servers, controllers, APs, etc.). In addition, the components herein may be implemented on a singular device or in a distributed manner, in which case the combination of executing devices can be viewed as their own singular “device” for purposes of executing the process(es).

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi7®)/Wi-Fi8® etc., IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, load balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as 'messages', 'messaging', 'signaling', 'data', 'content', 'objects', 'requests', 'queries', 'responses', 'replies', etc. which may be inclusive of packets. As referred to herein and in the claims, the term 'packet' may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a 'payload', 'data payload', and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in 'one embodiment', 'example embodiment', 'an embodiment', 'another embodiment', 'certain embodiments', 'some embodiments', 'various embodiments', 'other embodiments', 'alternative embodiment', and the like are intended to mean that any such features are included in one or more embodiments of the present disclosure, but may or may not necessarily be combined in the same embodiments. Note also that a module, engine, client, controller, function, service, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase 'at least one of', 'one or more of', 'and/or', variations thereof, or the like are open-ended expressions that are both conjunctive and disjunctive in operation for any and all possible combination of the associated listed items. For example, each of the expressions 'at least one of X, Y and Z', 'at least one of X, Y or Z', 'one or more of X, Y and Z', 'one or more of X, Y or Z' and 'X, Y and/or Z' can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms 'first', 'second', 'third', etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, 'first X' and 'second X' are intended to designate two 'X' elements that are not necessarily limited by any order, rank, importance, temporal sequence, or hierarchy of the two elements. Further as referred to herein, 'at least one of' and 'one or more of' can be represented using the '(s)' nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method, comprising:
determining, by an access point multi-link device, that a neighboring access point multi-link device is capable of multi-access-point coordination across a plurality of links;
establishing, by the access point multi-link device, a coordinated operation with the neighboring access point multi-link device based on at least one shared channel condition across affiliated access points;
obtaining, by the access point multi-link device, traffic information associated with one or more links of the neighboring access point multi-link device; and
selecting, by the access point multi-link device, a transmission action for a transmit opportunity based on the traffic information as obtained across the plurality of links.

2. The method of claim 1, wherein determining capability comprises:
receiving capability signaling in a multi-link operation element.

3. The method of claim 1, further comprising:
biasing channel selection of affiliated access points to align with channels of the neighboring access point multi-link device.

4. The method of claim 1, wherein establishing coordinated operation comprises:
identifying a shared primary channel between affiliated access points.

5. The method of claim 1, wherein obtaining traffic information comprises:
receiving buffered traffic information for uplink and downlink traffic.

6. The method of claim 1, wherein the traffic information includes an indication of links on which traffic is eligible to be transmitted.

7. The method of claim 1, wherein selecting the transmission action comprises:
granting at least a portion of the transmit opportunity to another access point.

8. The method of claim 1, wherein selecting the transmission action comprises:
prioritizing traffic based on information aggregated across multiple links.

9. The method of claim 1, further comprising:
caching the traffic information as obtained for use in subsequent transmit opportunities.

10. The method of claim 1, wherein the transmission action is based further on service period block acknowledgment information aggregated across multiple links.

11. An apparatus, comprising:
one or more network interfaces to communicate with a wireless network;
a processor coupled to the one or more network interfaces and configured to execute one or more processes; and
a memory configured to store a process that is executable by the processor for operating as an access point multi-link device, the process comprising:
determining that a neighboring access point multi-link device is capable of multi-access-point coordination across a plurality of links;
establishing a coordinated operation with the neighboring access point multi-link device based on at least one shared channel condition across affiliated access points;
obtaining traffic information associated with one or more links of the neighboring access point multi-link device; and
selecting a transmission action for a transmit opportunity based on the traffic information as obtained across the plurality of links.

12. The apparatus of claim 11, wherein determining capability comprises:
receiving capability signaling in a multi-link operation element.

13. The apparatus of claim 11, wherein the process further comprises:
biasing channel selection of affiliated access points to align with channels of the neighboring access point multi-link device.

14. The apparatus of claim 11, wherein establishing coordinated operation comprises:
identifying a shared primary channel between affiliated access points.

15. The apparatus of claim 11, wherein obtaining traffic information comprises:
receiving buffered traffic information for uplink and downlink traffic.

16. The apparatus of claim 11, wherein the traffic information includes an indication of links on which traffic is eligible to be transmitted.

17. The apparatus of claim 11, wherein selecting the transmission action comprises:
granting at least a portion of the transmit opportunity to another access point.

18. The apparatus of claim 11, wherein selecting the transmission action comprises:
prioritizing traffic based on information aggregated across multiple links.

19. The apparatus of claim 11, wherein the process further comprises:
caching the traffic information as obtained for use in subsequent transmit opportunities.

20. A non-transitory computer-readable medium storing computer-executable instructions that, when executed by one or more processors, cause a device to perform operations comprising:
determining, as an access point multi-link device, that a neighboring access point multi-link device is capable of multi-access-point coordination across a plurality of links;
establishing a coordinated operation with the neighboring access point multi-link device based on at least one shared channel condition across affiliated access points;
obtaining traffic information associated with one or more links of the neighboring access point multi-link device; and
selecting a transmission action for a transmit opportunity based on the traffic information as obtained across the plurality of links.
